(19) United States
(12) Patent Application Publication
(10) Pub. No.: US 2010/0043717 A1
(43) Pub. Date: Feb. 25, 2010

(54) LITTER CONTAINMENT AND DISPOSAL APPARATUS

(76) Inventor: Ernest Walker, Staten Island, NY (US)

Correspondence Address: MEREDITH & KEYHANI, PLLC, 330 MADISON AVE., 6TH FLOOR, NEW YORK, NY, 10017, US

(21) Appl. No.: 12/510,183

(22) Filed: Jul. 27, 2009

Related U.S. Application Data
(63) Continuation-in-part of application No. 11/691,534, filed on Mar. 27, 2007, now abandoned.
(60) Provisional application No. 60/787,140, filed on Mar. 29, 2006.

(51) Int. Cl. A01K 29/00

(52) U.S. Cl. 119/167; 119/165; 119/171; 119/166

(57) ABSTRACT

A litter containment and disposal apparatus is provided, the apparatus comprising: an open top rectangular portion having a bottom with at least one cutout opening therein and at least three sides; a drawer in communication with a portion of the bottom, wherein the drawer is directly below and slightly larger than the at least one cutout opening; and a container comprising a support portion and a liquid impervious shell which may contain absorbent material attached to the support portion, wherein the support portion is smaller than the drawer and adapted to fit inside the drawer and liquid impervious shell containing absorbent material hangs from the support portion below the drawer.

This application is a continuation in part of U.S. patent Ser. No. 11/691,534 entitled “Litter Containment and Disposal Apparatus” filed Mar. 27, 2007 which claims priority to provisional patent application No. 60/787,140 entitled “Kitty's Kastle” filed Mar. 29, 2006 both of which are incorporated by reference in their entirety.

The present invention relates to animal litter apparatus, and in particular to an improved cat litter box. Cats instinctively bury their waste, which makes them easy to litter train. Pet owners, though, dread cleaning the litter box which is may have a strong odor and be unsanitary. The problem is compounded when a pet owner own multiple cats. Consumers that would like to have litter-trained pets are often deterred by the thought of a potentially smelly litter box. The present invention absorbs, neutralizes and deodorizes the smells associated with litter systems and enables pet owners to quickly and easily clean the litter area. The present invention provides a contained bag and/or strip that is filled with an absorbent material, so it is self contained and the bag may be removed.

Accordingly, the present invention provides an easier and more effective method of cleaning soiled pet litter from a litter that may include an innovative screen and a sliding try, wherein solid wastes deposited on the surface can be removed easily for disposal, while liquid waste will be directed to a recess area that can provide the ability to neutralize and deodorize the immediate and surrounding area in certain compositions. This is more pleasing to the animal, as litter remains drier and free of bacteria and odor. Also, changing a litter box is easier with removable contained absorbent bags and litter stays fresher longer, saving time and money.

### SUMMARY OF THE INVENTION

The present invention relates generally to an apparatus for containing and easily disposing of animal litter.

According to one embodiment, a litter containment and disposal apparatus comprising: an open top rectangular portion having a bottom with at least one cutout opening therein and at least three sides; a base portion in communication with the bottom having a drawer, wherein the drawer is directly below and slightly larger than the at least one cutout opening; and an absorbent bag container comprising a support portion and a liquid impervious shell containing absorbent material attached to the support portion, wherein the support portion is smaller than the drawer and adapted to fit inside the drawer and the liquid impervious shell containing absorbent material hangs from the support portion below the drawer.

According to another embodiment, a litter containment and disposal apparatus is provided, the apparatus comprising: an open top rectangular portion having a bottom with at least one cutout opening therein and at least three sides; a drawer in communication with a portion of the bottom, wherein the drawer is directly below and slightly larger than the at least one cutout opening; and an absorbent bag container comprising a support portion and a liquid impervious shell containing absorbent material attached to the support portion, wherein the support portion is smaller than the drawer and adapted to fit inside the drawer and liquid impervious shell containing absorbent material hangs from the support portion below the drawer.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

FIG. 9 depicts the present invention;

FIG. 10 depicts the present invention;

FIG. 11 depicts the present invention;

FIG. 12 depicts the present invention; and

FIG. 13 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention was redeveloped as an easier and more effective apparatus to clean pet litter from a litter box. A supporting portion may sit in and be supported by a drawer formed by opposing L portions with waste contained in a liquid impervious shell (e.g. a bag) that hangs from the supporting portion. Solid waste may remain on the top of kitty litter and liquid waste may travel through the kitty litter to be trapped in the absorbent bag container. The absorbent material in the absorbent bag container neutralizes and deodorizes the waste.

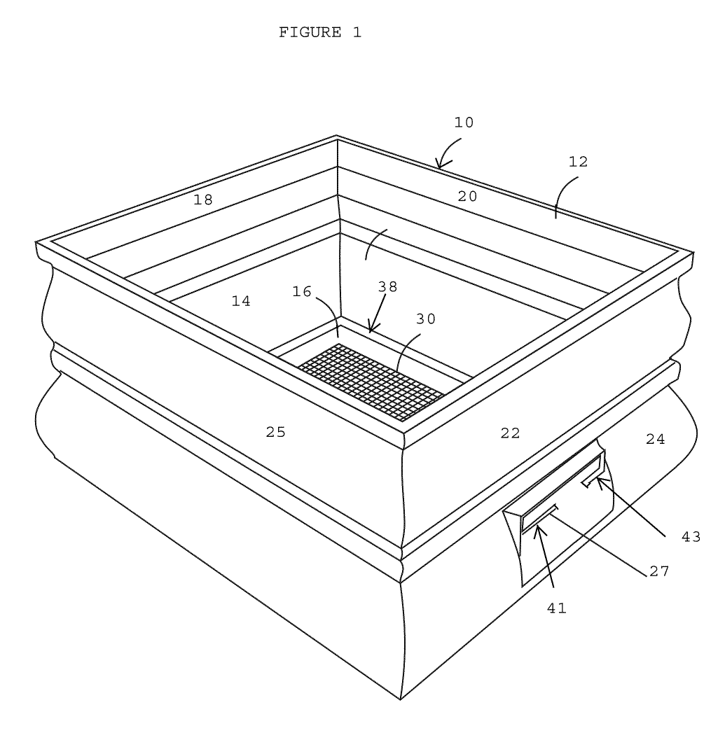

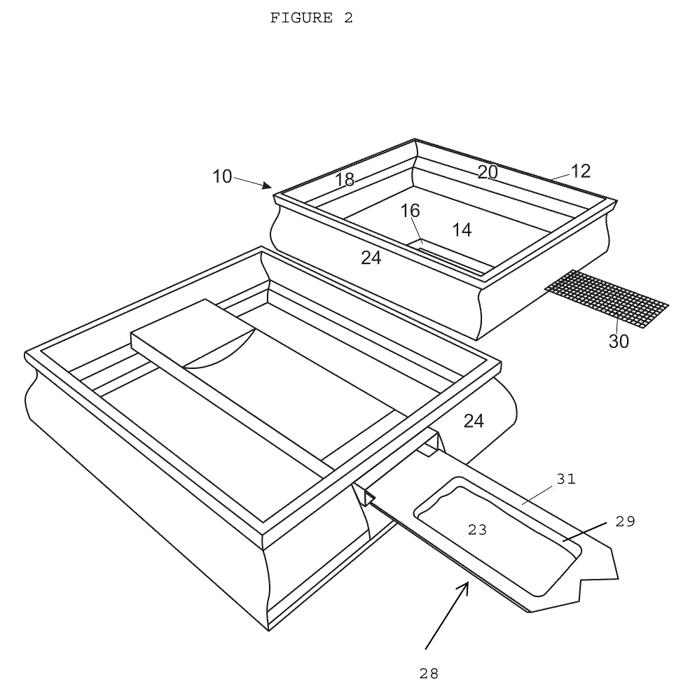

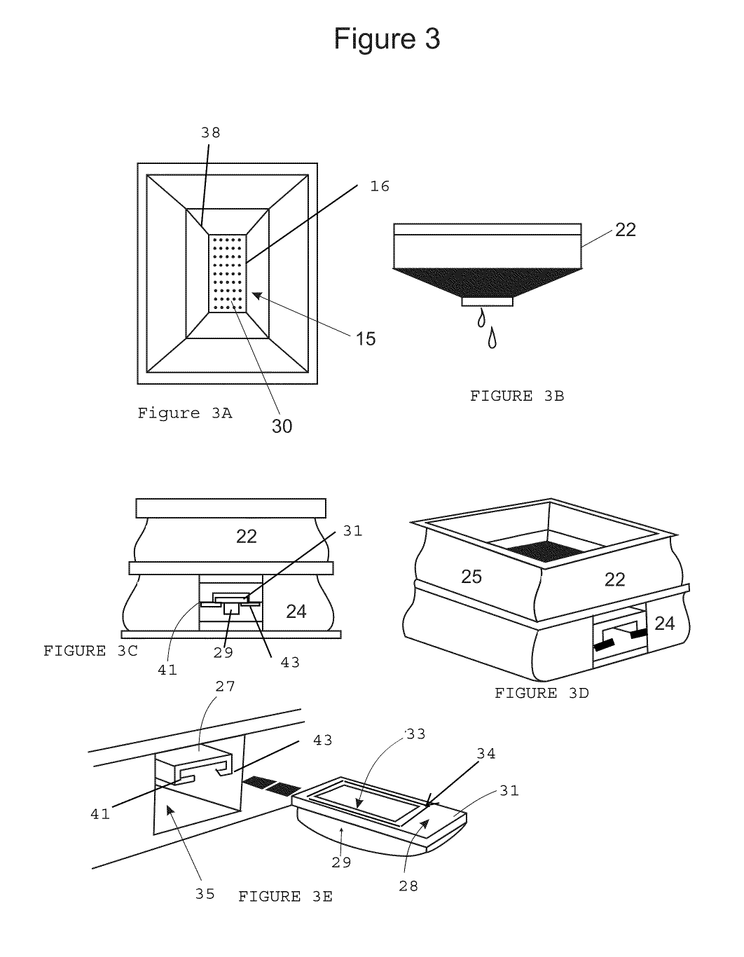

According to one embodiment, a litter containment and disposal apparatus is provided, as shown in FIGS. 1-4. The apparatus (10) comprising: an open top rectangular portion (12) having a bottom (14) with at least one cutout opening (16) therein and at least three sides (18, 20, 22, 25); a base portion (24) in communication with the bottom (14) having a drawer (27) formed by opposing L portions (41 and 43), wherein the receiving bottom (73) may be directly below and slightly larger than the at least one cutout opening (16); and an absorbent bag container (28), wherein the absorbent bag container (28) has a supporting portion (31) that is smaller than the drawer (27) and adapted to slide inside the drawer (27) for easy insertion and removable to provide a disposable absorbent bag container (28) which contains an absorbent material (23) surrounded by an liquid impervious shell (29). As shown, the drawer (27) is made up of opposing L portions (41 and 43). The sides of the supporting portion (31) that is smaller than the drawer (27), slide into the opposing L portions (41 and 43) and the liquid impervious shell (29) hangs below the supporting portion (31). The L shaped brackets (41 and 43) support the edge of the supporting portion (31) which is the top of the absorbent bag container (28). This allows the absorbent bag container (28) to slide in and out of the brackets like a drawer for easy insertion and removal. The term absorbent bag container (28) refers to the entire container made up of the parts such as supporting portion (31), absorbent material (23) and liquid impervious shell (29). The liquid impervious shell (29) may be expandable to accommodate larger amounts of liquid without spillage. The opening below the L shaped brackets (41 and 43) may be any width (of course the width must be smaller than the width of the base portion as it is within the base portion) to accommodate an expanding container. The container may be or even expand wider than the opposing L portions, as the container expands. There may also be a screen (30), wherein the screen (30) is in communication with and covers the cutout opening (16). The screen (30) may be above or below the cutout opening (16). The bottom (14) may be sloped, as shown in FIG. 3A, having a sloped bottom portion (15) or concaved towards the cutout opening (16). The animal, such as a cat, would situate themselves in the open (or topless) open top rectangular portion (12), which is slightly inward sloping, beveled or concaved edges which may position towards the center of the unit. The beveled or concaved edges prevent urine from forming a puddle at the bottom of the pan, as liquid waste that is not absorbed by the litter is directed through a screen at the bottom of the container. The centralized, interchangeable screen allows urine to pass but feces and litter of choice will remain atop for easy cleaning. Any desired type of litter may be placed in the upper container (open top rectangular portion) to provide sufficient material for use in covering waste. It is also envisioned that a non-absorbent, waterproof (or water repellent) material with good drainage properties and a pleasing granular texture to cats may be placed in the open top rectangular portion. Examples of such a material may be plastic granules, sand (around 2 mm) or other silica/silicon based or Teflon infused materials. This would provide for a semi-permanent litter requiring few changes. The absorbent material (23) may be cellulosic airlaid webs of comminuted fibers, wood cellulose fibers, cellulose-superabsorbent mixtures or composites, hydroentangled webs comprising cellulosic fibers, composites of synthetic fibers and papermaking fibers such as coform, rayon, lyocell, solvent-spun hydrophilic fibers, cellulosic foams including regenerated cellulose foams; hydrophilic, flexible foams, absorbent foams, fiber-foam composites, absorbent nonwoven webs, cotton, wool or keratin fibers, peat moss, silica gel, super absorbent polymer (SAP), hydrogels, sodium polyacrylate, non-woven fibers, Polypropylene fibers and other absorbent vegetable matter. According to a preferred embodiment, the absorbent material is SAP. According to another preferred embodiment, the absorbent material is Polypropylene fibers, which improve the urine distribution and reduces need of the bulky pulp fluff, while improving SAP's efficiency. It is important, though, that the absorbent material (23) be contained in the liquid impervious shell (29) of the absorbent bag container (28) to provide easy, mess free disposal. The urine would flow through cutout opening (16), with any feces staying above the screen (30), and be absorbed by the absorbent material (23). As liquid waste accounts for the majority of litter pan and sanitation problems, this provides a run-off method and provides and easy and convenient system for disposal. There is no removal of clumping product or wet litter to dispose of and a safe environment is provided for cats and kittens, as no chemical or dust particles are released.

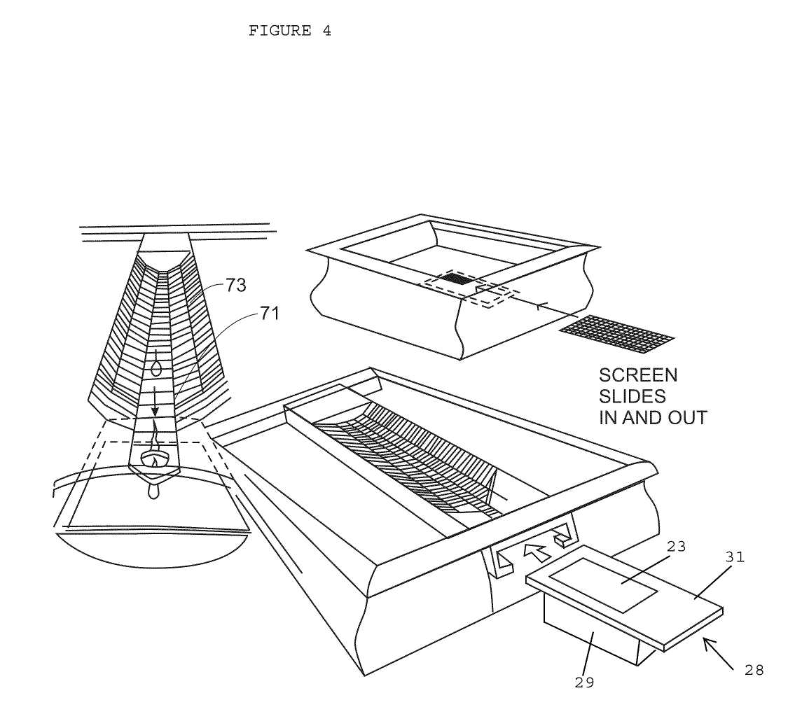

As shown in FIG. 3E, the absorbent bag container (28) may have an open rectangular cardboard supporting portion (31) in communication with an liquid impervious portion (29) containing absorbent material (23), wherein the opening (33) in the open rectangular cardboard supporting portion (31) is aligned under the cutout opening (16) in the bottom (14) of the apparatus (10). The drawer (27) may receive the supporting portion (31) of the absorbent bag container (28) which may be made of cardboard (or thin plastic similar to that plastic cups are made of) to provide a disposable absorbent bag container (28) having a liquid impervious portion (29) containing the absorbent material (23) that hangs below the drawer (27) and above the floor (35) of base portion (24). The present invention envisions disposable, non-disposable and semi-disposable containers. The disposable unit is flat and requires little space, but can expand downwards up to ten times its size to absorb waste without overflowing. The non-disposable unit may be an empty vessel and not filled with anything (no absorbent material). The function is a collection method. A semi-disposable unit is the same as the non-disposable unit except it is made from disposable plastic cup like material and can be discarded or reused. There may also be an adhesive tape material (34) in communication with the top of the supporting portion (31). The adhesive tape material (34) acts to seal the top of the absorbent bag container (28) when removed from the apparatus (10) to provide a leak free seal and disposal when thrown away. The adhesive tape material (34) may cover and seal the top of the supporting portion (31) after the absorbent bag container (28) has been filled. The adhesive tape material is tape of the absorbent bag container (28) to prevent leakage. According to a preferred embodiment, the drawer (27) may be made up by opposing L portions (41, 43) and the supporting portion (31) of the absorbent bag container (28) fits into the opposing L portions (41, 43) of the drawer (47) to allow the liquid impervious shell (29) containing the absorbent material (23) to hang below the cutout opening (16) while supported by the opposing L portions (41, 43) as shown in FIG. 3C. As depicted in FIG. 4, there may also optionally be a channel (71) and a receiving bottom (73). The channel may divert liquids to the at least one cutout opening. The liquid channel may take many different forms. The receiving bottom (73) may also be an inclined drip pan which acts to channel liquid to the absorbent material (23) of the bag container (28). According to another embodiment, the supporting portion (31) may be made of metal or any other solid material Also, according to another alternate embodiment, there may a commercially available absorbent pad (such as a diaper or feminine pad) placed under the cutout opening (16) which may act as or replace the container to absorb liquids.

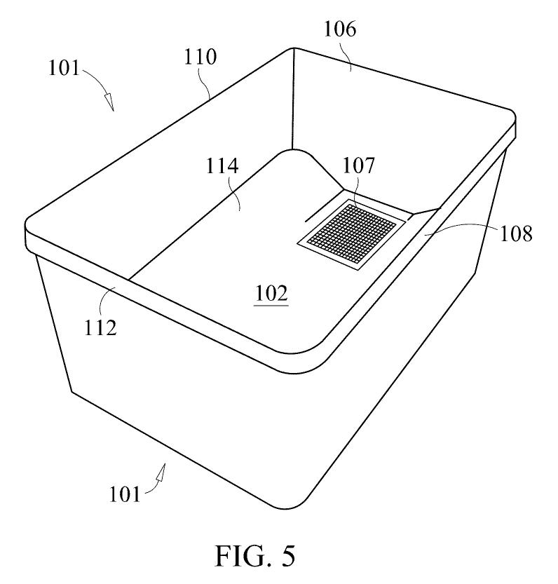

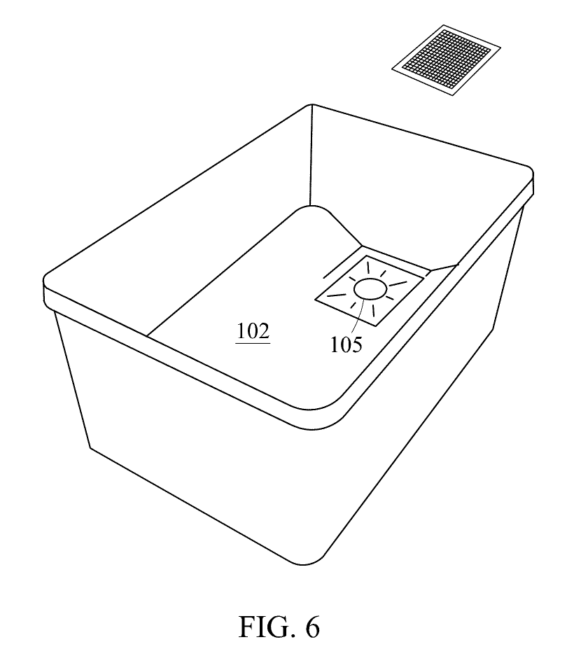

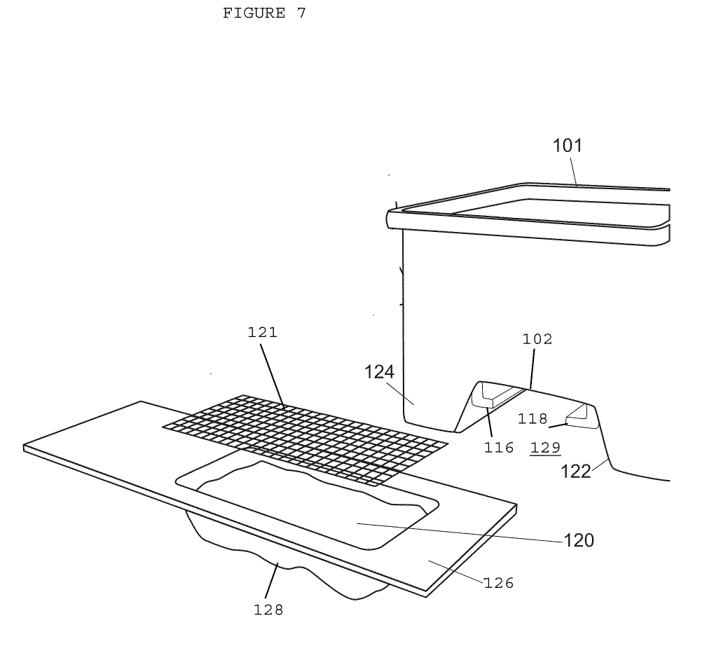

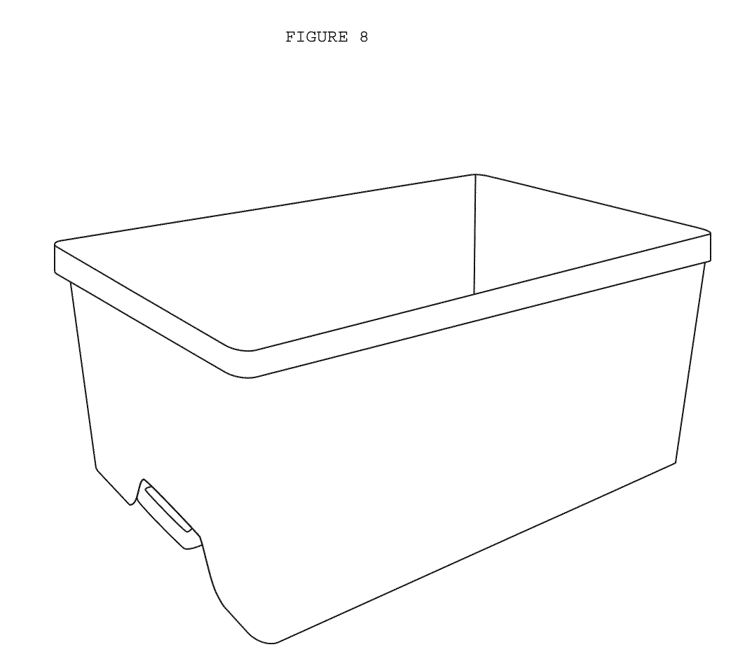

Turning to FIGS. 5-8, a litter containment and disposal apparatus is provided, the apparatus comprising: an open top rectangular portion (101) having a bottom (102) with at least one cutout opening (105), which may act as a drain, therein and at least three sides (106, 108, 110, 112); a drawer comprising and formed by opposing L portions (116 and 118) is in communication with a portion of the bottom (102), wherein the drawer formed by opposing L portions (116 and 118) is directly below and slightly larger than the at least one cutout opening (104); and an absorbent bag container (120), wherein the supporting portion (126) is smaller than and adapted to fit inside the opposing L portions (116 and 118). According to this embodiment, the unit is a single unit open top rectangular portion. In this situation, there may be legs (122, 124) which provide a raised bottom (102), as depicted in FIG. 7. This is important as the opposing L portions (116 and 118) must allow the supporting portion (126) to be supported with the liquid impervious shell (128) hanging below the supporting portion (126). The liquid impervious shell may be above the ground (129) or expand to touch the ground. The space between the legs (122, 124) may be any width between the legs to accommodate an expanding container. The container may be or even expand wider than the opposing L portions, as the container expands along folds. According to one embodiment, the distance between the raised bottom (102) and the ground (129) may be between one and ten inches, preferably between 3 and 6 inches. There may be flooring added to this container. This is important, because the hanging bag allows for expansion. There may also be kitty litter along the bottom (102) of the open top rectangular portion (101). As stated previously, any type of kitty litter may be used in accordance with the present invention. There may be a screen (107), wherein the screen (107) is in communication with and covers the cutout opening (105). The bottom (102) may be sloped or concaved towards the cutout opening (105). There may also be at least one channel (114) in the bottom, wherein the at least one channel directs liquids to the cutout opening. The channel may be a concave bottom which directs liquids to the cutout opening, as in depicted in 5.

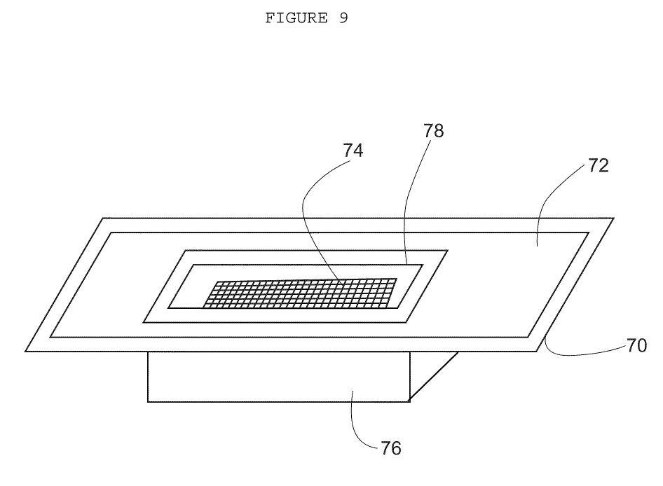

As shown in FIG. 9, there may also be a supporting portion (70), wherein the opening (78) in the supporting portion (70) is aligned under the cutout opening (16) in the bottom (14) of the apparatus (10). The drawer supporting portion (70) may be made of metal or any other solid material. The tape would not be required when the drawer supporting portion is a non-disposable unit made of metal. Also, the absorbent bag container would not be present. The drawer may be comprised of a receiving portion with opposing L portions and the top flat portion (70) fits into the receiving portion opposing L portions.

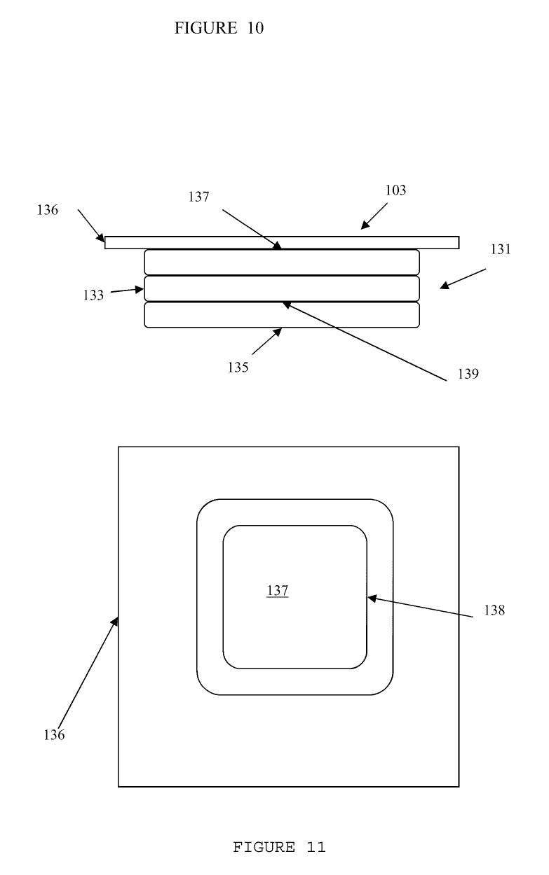

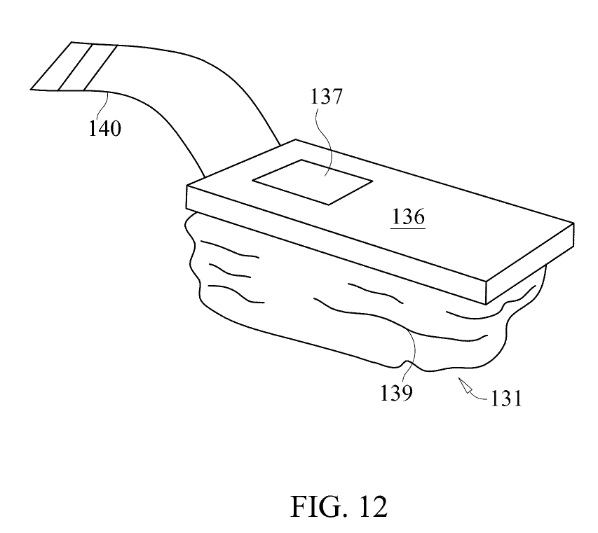

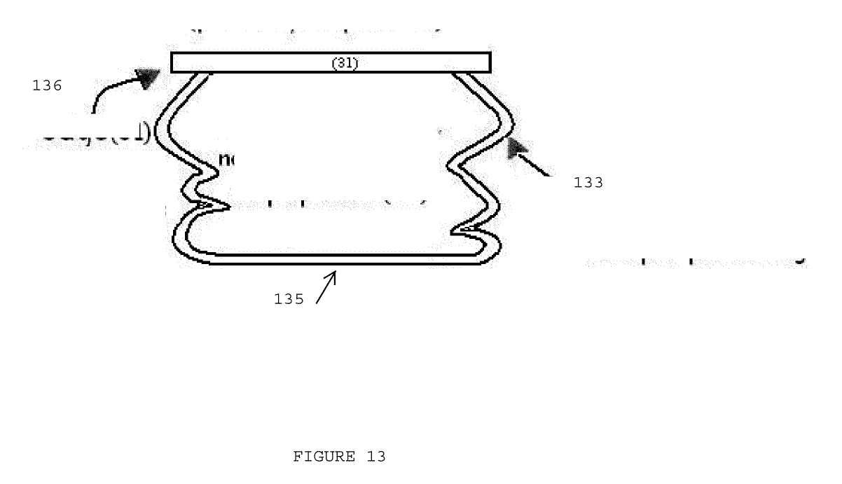

As shown in FIGS. 10-13, the absorbent bag container (103) may further have a side wall (133), wherein the side wall (133) is liquid impervious and is between the liquid impervious backsheet (135) and may have a liquid pervious topsheet (137) and has at least one fold (139) to allow the absorbent bag (131) to expand. The absorbent bag container (103) may be round, oval, bag shaped, rectangular or any other desired shape. The side wall (1303) is made of liquid impervious material. There may also be an adhesive tape material (140) in communication with the supporting portion (136) to provide secure disposal. There is an opening (138) in the supporting (136) and there may be the liquid pervious topsheet (137) below the opening (138).

The absorbent bag container may have a liquid impervious backsheet; a liquid pervious topsheet attached to the backsheet; an absorbent material that is at the core or center and disposed between the topsheet and the backsheet. The absorbent bag container has a liquid pervious cover and an absorbent core disposed contained inside the liquid pervious cover. This is to say it may be round, oval or bag shaped. Containers can come in many sizes, forms and shapes. The liquid pervious cover may be a single piece sewn or affixed together to form a round oval or bag shape. There may also be a liquid pervious testing sheet above (or in place of) the liquid pervious cover. As used herein, a material is said to be “absorbent” if it can retain an amount of water equal to at least 100% of its dry weight as measured by the test for Intrinsic Absorbent Capacity given below (i.e., the material has an Intrinsic Absorbent Capacity of at about 1 or greater). Desirably, the absorbent materials used in the absorbent members of the present invention have an Intrinsic Absorbent Capacity of about 2 or greater, more specifically about 4 or greater, more specifically still about 7 or greater, and more specifically still about 10 or greater, with exemplary ranges of from about 3 to about 30 or from about 4 to about 25 or from about 12 to about 40.

The absorbent material may be cellulosic airlaid webs of comminuted fibers (commonly termed “airfelt”); wood cellulose fibers; cellulose-superabsorbent mixtures or composites; hydroentangled webs comprising cellulosic fibers; composites of synthetic fibers and papermaking fibers such as coform, as disclosed in U.S. Pat. No. 4,879,170, issued Nov. 7, 1989 to Radwanski et al.; rayon; lyocell or other solvent-spun hydrophilic fibers, such as those disclosed in U.S. Pat. No. 5,725,821, issued Mar. 10, 1998 to Gannon et al.; cellulosic foams including regenerated cellulose foams; hydrophilic, flexible foams or absorbent foams produced from high internal phase emulsions (HIPE), such as the foams disclosed in U.S. Pat. No. 5,692,939, issued Dec. 2, 1997 to DesMarais; fiber-foam composites; absorbent nonwoven webs; cotton; wool or keratin fibers; peat moss and other absorbent vegetable matter, and any other known absorbent material. The liquid impervious backsheet may be made with a moisture-proof plastic such as polypropylene or polyethylene

There may also be a health indicator test which may be in communication with at least a portion of the absorbent bag container. By way of example, the health indicator test may be a reagent paper that is in communication with (or in place of) the liquid pervious topsheet (137). The reagent paper may test indicate the presence of an alkaline pH and/or occult blood.

It should be understood that the foregoing relates to preferred embodiments of the invention and that modifications may be made without departing from the spirit and scope of the invention as set forth in the following claims.

I claim:

1. A litter containment and disposal apparatus, said apparatus comprising:
an open top rectangular portion having a bottom with at least one cutout opening therein and at least three sides;
a base portion in communication with said bottom having a drawer, wherein said drawer is directly below and slightly larger than said at least one cutout opening; and
a container comprising a support portion and a liquid impervious shell attached to said support portion, wherein said support portion is smaller than said drawer and adapted to fit inside said drawer and said liquid impervious shell containing hangs from said support portion below said drawer.

2. A litter containment and disposal apparatus as in claim 1, wherein said liquid impervious shell is expandable.

3. A litter containment and disposal apparatus as in claim 1, said liquid impervious shell containing absorbent material.

4. A litter containment and disposal apparatus as in claim 1, further comprising a screen, wherein said screen is in communication with and covers said cutout opening.

5. A litter containment and disposal apparatus as in claim 1, wherein said container is an absorbent bag container and said absorbent bag container is further comprising a side wall, wherein said side wall is between said liquid impervious backsheet and said a liquid pervious topsheet and has at least one fold to allow said absorbent bag to expand.

6. A litter containment and disposal apparatus as in claim 1, wherein said bottom with a cutout opening therein and said bottom is sloped towards said cutout opening.

7. A litter containment and disposal apparatus as in claim 1, further comprising at least one liquid channel in said bottom for diverting liquids to said container.

8. A litter containment and disposal apparatus as in claim 1, wherein said absorbent material is selected from the group consisting of cellulosic airlaid webs of comminuted fibers, wood cellulose fibers, cellulose-superabsorbent mixtures or composites, hydroentangled webs comprising cellulosic fibers, composites of synthetic fibers and papermaking fibers such as coform, rayon, lyocell, solvent-spun hydrophilic fibers, cellulosic foams including regenerated cellulose foams; hydrophilic, flexible foams, absorbent foams, fiber-foam composites, absorbent nonwoven webs, cotton, wool or keratin fibers, peat moss, silica gel, super absorbent polymer, hydrogels, sodium polyacrylate and other absorbent vegetable matter.

9. A litter containment and disposal apparatus as in claim 1, wherein said support portion is an open rectangular cardboard portion having an opening that is aligned under said cutout opening in said bottom of said apparatus when said support portion is inside said drawer.

10. A litter containment and disposal apparatus as in claim 9, further comprising an adhesive tape material in communication with said open rectangular cardboard portion.

11. A litter containment and disposal apparatus as in claim 1, wherein said container is an absorbent bag container and has a liquid pervious cover and an absorbent material contained inside said liquid pervious cover.

12. A litter containment and disposal apparatus as in claim 1, further comprising a health indicator test in communication with at least a portion of said absorbent bag container.

13. A litter containment and disposal apparatus, said apparatus comprising:
an open top rectangular portion having a bottom with at least one cutout opening therein and at least three sides;
a drawer in communication with a portion of said bottom, wherein said drawer is directly below and slightly larger than said at least one cutout opening; and
a container comprising a support portion and a liquid impervious shell attached to said support portion, wherein said support portion is smaller than said drawer and adapted to fit inside said drawer and liquid impervious shell hangs from said support portion below said drawer.

14. A litter containment and disposal apparatus as in claim 13, wherein said liquid impervious shell is expandable.

15. A litter containment and disposal apparatus as in claim 13, said liquid impervious shell containing absorbent material.

16. A litter containment and disposal apparatus as in claim 13, further comprising a screen, wherein said screen is in communication with and covers said cutout opening.

17. A litter containment and disposal apparatus as in claim 13, said absorbent bag container further comprising a side wall, wherein said side wall is between said liquid impervious backsheet and said a liquid pervious topsheet and has at least one fold to allow said absorbent bag to expand.

18. A litter containment and disposal apparatus as in claim 13, wherein said bottom with a cutout opening therein is sloped towards said cutout opening.

19. A litter containment and disposal apparatus as in claim 13, wherein said absorbent material is selected from the group consisting of cellulosic airlaid webs of comminuted fibers, wood cellulose fibers, cellulose-superabsorbent mixtures or composites, hydroentangled webs comprising cellulosic fibers, composites of synthetic fibers and papermaking fibers such as coform, rayon, lyocell, solvent-spun hydrophilic fibers, cellulosic foams including regenerated cellulose foams; hydrophilic, flexible foams, absorbent foams, fiber-foam composites, absorbent nonwoven webs, cotton, wool or keratin fibers, peat moss, silica gel, super absorbent polymer, hydrogels, sodium polyacrylate, and other absorbent vegetable matter.

20. A litter containment and disposal apparatus as in claim 13, wherein said support portion is an open rectangular cardboard portion having an opening that is aligned under said cutout opening in said bottom of said apparatus when said support portion is inside said drawer.

21. A litter containment and disposal apparatus as in claim 13, further comprising an adhesive tape material in communication with said top rectangular cardboard portion.

22. A litter containment and disposal apparatus as in claim 13, further comprising at least one liquid channel in said bottom for diverting liquids to said container.

23. A litter containment and disposal apparatus as in claim 15, wherein said container is an absorbent bag container and has a liquid pervious cover and an absorbent core disposed and contained inside said liquid pervious cover.
